(19) United States
(12) Patent Application Publication
(10) Pub. No.: US 2002/0086798 A1
(43) Pub. Date: Jul. 4, 2002

(54) Product label and product label issuing machine

(75) Inventors: Toshiyuki Tamura, Mishima-shi (JP); Takayuki Hiyoshi, Suntoh-gun (JP); Yukihiro Takada, Tagata-gun (JP); Yoshiaki Shibata, Yokohama-shi (JP); Yuichiro Hatanaka, Tagata-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Toshiba TEC Kabushiki Kaisha, Tokyo (JP)

(21) Appl. No.: 09/987,278

(22) Filed: Nov. 14, 2001

(30) Foreign Application Priority Data
Nov. 14, 2000 (JP) 2000-346396
Oct. 25, 2001 (JP) 2001-327560

(51) Int. Cl. B32B 9/00

(52) U.S. Cl. 503/218; 428/41.8

(57) ABSTRACT

A product label in which goods figure indicating the form of goods or a portion thereof is printed together with sales information of the goods, and which can associate the content of the goods to some extent through the product label to provide a product label having high sales promotion effect. Particularly, it can provide indication that can be seen easily and effectively by printing the goods figure in a color that associates the goods, for example, in a color similar or identical with the color of the goods or a portion thereof, to give more effective sales promotion, and can also provide indication that can be seen easily and effectively by printing the goods figure in a color different from that of the printed letters for the content of goods to give more effective sales promotion.

### CROSS REFERENCE TO RELATED APPLICATIONS

The present application is based on Japanese Priority Documents 2000-346396 filed on Nov. 14, 2000 and 2001-327560 filed on Oct. 25, 2001 the content of which is incorporated herein by reference.

### BACKGROUND OF THE INVENTION

1. Field of the Invention

The present invention relates to a product label and, more in particular, it relates to a sales promotion label, for example, a product label used on foodstuffs such as meat and fish displayed on selling stores, as well as a label issuing machine for issuing the product labels.

2. Discussion of the Background

Generally, a product label which is used for the sale of foodstuffs and on which sales information of the goods is printed comprises a sales promotion indication area for indicating the sales promoting information and a goods content indication area for explaining the content of the goods. Letters such as for special price, illustration and POP advertisement are printed in the sales promotion indication area and goods name, data for measured weight, fixed price, production date and bar code are printed in the goods content indication area.

For example, Japanese Published Unexamined Patent Application 2000-98897 discloses a product label comprising a sales promotion indication area and a goods content indication area in which the sales promotion indication area is printed in a color different from that for the goods content indication area. Japanese Published Unexamined Patent Application Hei 11-7243 discloses a label of printing an emphasized indication area (an emphasis region) and a goods content indication area (a non-emphasis region) by different colors using heat sensitive paper that forms two kinds of colors depending on the level of the heating temperature Message such as information for special price and service goods of the month or the illustrations are printed in the emphasized indication area. Japanese Published Unexamined Patent Application Hei 10-337911 describes means for attaining the method of two color printing by the combination of heat sensitive paper and a thermal transfer system.

However, while such product labels specifically describe the contents for the sales promotion of the goods but the content of the goods can be recognized only when a customer actually accesses the goods, since the customer can recognize the image of the targeted goods only by means of the name of goods when looking at the product label.

Further, referring to the price, since it does not indicate the actual price purchased by the customer, the customer has to calculate the sum to be paid finally.

That is, the existent labels involve problems in. that indication is made only for the sales promotion of shops but not for the convenience of the customers.

Referring to the sales promotion information for the customers, a method of using two color heat sensitive paper or plural printing systems has been proposed as a method of indicating different colors for the areas to be emphasized in order to further appeal the goods. However, two color heat sensitive paper requires to provide high and low levels in view of thermal energy for each of heat sensitive layers, which complicates the control and requires high temperature heating, so that it may be worried that printing speed is restricted, working life of the thermal head is deteriorated and the color mixing is inevitable since a lower temperature area is present at the periphery of the high temperature heating. Further, the method of using an ink jet and a thermal transfer system in combination may be considered to increase the cost of the apparatus since plural printing systems are required.

### SUMMARY OF INVENTION

In view of the above, the present invention intends to provide a product label in which goods content is specifically printed for the sake of customers and a product label issuing machine for issuing the product label.

The object of the present invention is achieved by the novel product label and a product label issuing machine of the present invention.

According to the novel product label of the present invention, a goods figure that represents goods or a portion of the goods is printed as sales information of the goods.

According to another aspect of the novel product label of the present invention, a sum to be paid by a customer is printed in emphasizing letters emphasized relative to other information printed in the goods content indication area.

According to the novel product label issuing machine of the present invention, a goods figure representing the form of goods or a portion of the goods, information for the color of the goods figure and sales information for the goods are read out sequentially in the order of printing, and the goods figure and the sales information of the goods are printed by a thermal head on a product label.

According to another aspect of the novel product label issuing machine of the present invention, the final price to be paid by a customer is calculated based on the information regarding the price of the goods and the information for the calculation of the final price of the goods stored in a memory region and the final price to be paid by the customer and the sales information of the goods are printed by a thermal head to the product label.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a plan view illustrating a product label in the first embodiment according to the present invention;

FIG. 2 is a cross sectional view thereof taken along line A-A;

FIG. 3(A) is a cross sectional view taken along line B-B in FIG. 1 that illustrates an example of a product label in a second embodiment according to the present invention;

FIG. 3(B) is a cross sectional view taken along line B-B in FIG. 1 that illustrates another example of a product label in the second embodiment according to the present invention;

FIG. 4 is a plan view illustrating a product label in a third embodiment according to the present invention;

FIG. 5 is a plan view illustrating a product label in a fourth embodiment according to the present invention;

FIG. 6 is a cross sectional view taken along line A-A thereof;

FIG. 7 is a perspective view for the appearance showing a product label issuing machine in a fifth embodiment according to the present invention;

FIG. 8 is a block diagram illustrating an example of the constitution of hardwares;

FIG. 9 is a front elevational view showing an example of indication on a screen of a display device:

FIG. 10 is a front elevational view illustrating an example of display upon changing operation on a screen of a display device; and

FIG. 11 is a front elevational view illustrating another example of display upon changing operation on a screen display device,

### DETAILED DESCRIPTION OF THE PREFERRED EMBODIMENTS

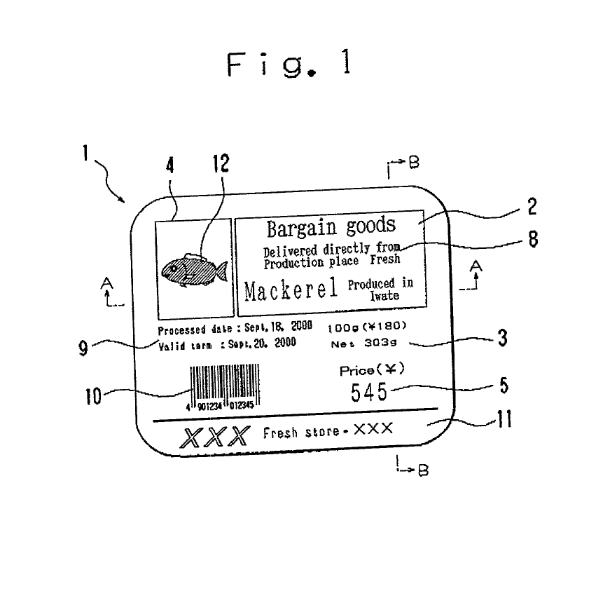

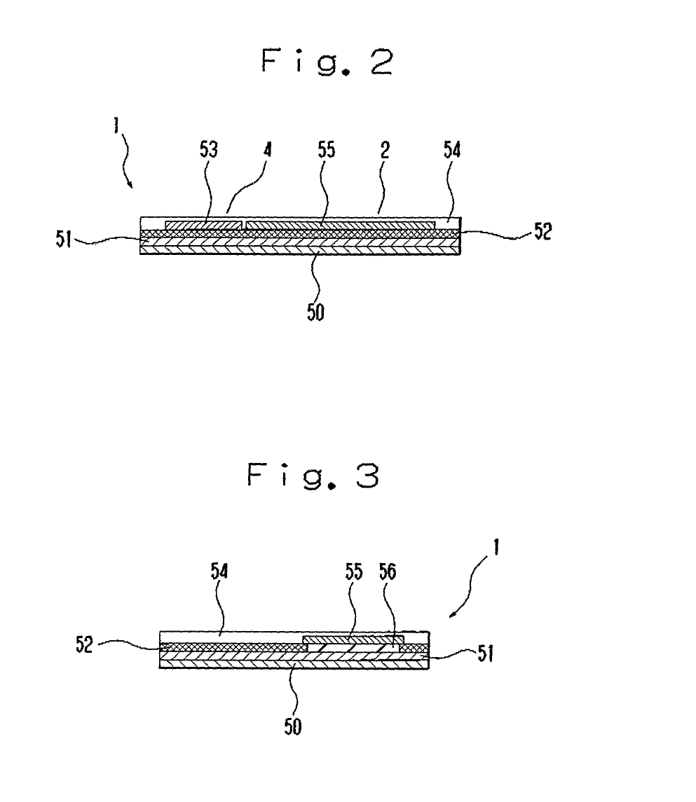

A first embodiment of the present invention is now explained with reference to FIG. 1 and 2.

FIG. 1 shows a product label of this embodiment issued from a product label issuing machine 100 according to the present invention to be described later. The product label comprises an emphasized indication area 2, a goods content indication area 3 and a goods figure display area 4 as the portion for indicating sales information of the goods. In the goods content indication area 3, are printed information for administration of goods such as the date of processing-and-valid term for use 9, fixed price 5 and bar code 10. Further, the name 11 of the store (such as a super market) has already been printed (which may be printed upon issue). Further, the emphasized indication area 2 is printed with emphasized information 8 (POP information) to be emphasized for the goods. For example, the special price or, depending on the case, information for direct delivery from the place of production or special place of production may also be printed.

The product label of the present invention may be called other name like package label, consumer package label or the like. The name of the product label, generally, depends on the goods to which the product label will be attached.

Further, in the product label 1 of this embodiment, a goods FIG. 12 designed so as to enable association for the targeted goods is printed in the goods figure indication area 4. For example, in a case where the targeted goods is “mackerel” as shown in FIG. 1, design of the mackerel (or fish) is printed as the goods FIG. 12. Further, since the mackerel has an image of a blue colored fish, for instance, a more effect can be obtained by printing the design area in blue. With such a constitution, a customer can associate the image of the goods.

Needless to say, it depends on culture whether certain goods has certain image or not. As described above, the mackerel has an image of a blue colored fish. The color image of the mackerel may be effective merely in Japan. Thus, the above mentioned color image of the mackerel is described as one example.

FIG. 2 shows a cross sectional view of the product label 1 according to this embodiment. An undercoat layer 51 comprising clay and binder resin, a heat sensitive recording layer (first heat sensitive recording layer) 52 and a heat sensitive color forming layer (second heat sensitive recording layer) 53 and, optionally, a protection layer 54 are disposed on a substrate 50. In this embodiment, the heat sensitive recording layer 52 is a heat sensitive layer forming a black color while the heat sensitive color forming layer 53 is a heat sensitive layer forming a blue color as a color for the image of the mackerel. Further, a heat sensitive recording layer 55 for the emphasis region that forms a red color is disposed to the emphasized indication area 2.

As a method of manufacturing such a product label 1, an ink comprising a leuco dye, a color developer, a sensitizer, a lubricant, calcium carbonate, a color formation inhibitor, a color formation stabilizer and binder resin is die coated on the undercoat layer 51 laminated on the substrate 50 by a printing method such as flexographic printing, screen printing or gravure printing. In this case, ODB-2 (manufactured by Yamamoto Kasei Co.) is used, for example, as the leuco dye of the heat sensitive recording layer 52, while CVL (manufactured by Yamanoto Kasei Co.) is used, for example, as the leuco dye of the heat sensitive color forming layer 53.

Description is to be made for more concrete manufacturing method.

The heat sensitive recording layer 52, the heat sensitive color forming layer 53 and the heat sensitive recording layer 55 for the emphasis region were formed to a dry film thickness of 5 μm by flexographic printing on the substrate 50 to which the undercoat layer 51 was disposed and then the protection layer 54 was coated by a die coating method to a dry film thickness of 2%, followed by calendering.

<Formulation of Ink for Heat Sensitive Recording Layer>Liquid developer dispersion

Developer: -4′-isopropoxydiphenyl sulfone liquid

| | | |
|---|---|---|
| dispersion (F-647, manufactured by Chukyo Oils | 17.5 | parts by weight |
| and Fats Co.) | | |
| Sensitizer: methylsteroamide liquid | 16 | parts by weight |
| dispersion (D-757, manufactured by Chukyo Oils | | |
| and Fats Co.) | | |
| Lubricant: zinc stearate liquid dispersion | 4 | parts by weight |
| Z-7-30, manufactured by Chukyo Oils and | | |
| Fats Co.) | | |
| Coloration inhibitor: paraffin wax liquid | 1.75 | parts by weight |
| dispersion (D-337, manufactured by Chukyo Oils | | |
| and Fats Co.) | | |
| Inorganic pigment: aluminum hydroxide | 1 | part by weight |
| PVA 117 (10% solution) | 2.5 | parts by weight |

The blend described above was dispersed by a paint shaker for three hours to obtain a liquid dispersion.

Further, 5 parts by weight of a liquid dispersion of leuco dye were mixed to form a coating liquid. There were used a liquid dispersion of ODB-2 (H-272, manufactured by Chukyo Oils and Fats Co.) as the leuco dye for the heat sensitive recording layer 52, a liquid dispersion crystal violet lacton (CVL) (Y-CVL liquid dispersion, manufactured by Chukyo Oils and Fats Co.) for the heat sensitive color forming layer 53 and a liquid dispersion of PSD-EM for red heat sensitive recording in the emphasized indication area 2 (H-683, manufactured by Chukyo Oils and Fats Co.).

The protection layer 54 was obtained by optionally coating 10% solution of PVA 117 to a dry film thickness of 2 μm by a die coating method.

According to the product label 1 as shown in FIG. 1 and FIG. 2, since the emphasized indication area 2, the goods content indication area 3 and the goods figure indication area 4 are not in a laminated state, there is no color mixing when printing is conducted to each of indication areas 2, 3 and 4, so that they can be formed as a heat sensitive recording layer or a heat sensitive color forming layer with high sensitivity.

Further, since each of the heat sensitive layers is not in a laminated structure, it is necessary that the heat sensitive recording layer 52, the heat sensitive color forming layer 53 and the heat sensitive recording layer 55 for the emphasis region can be printed by an identical quantity of thermal energy.

In this embodiment, description has been made to a case where the color of the heat sensitive color forming layer 53 disposed partially in the product label 1 is blue in the case of the mackerel. In a case where a green color is used for the image of vegetables, a product label 1 provided with a heat sensitive color forming layer 53 of forming a green color may be used. In a case of carrot, crab, apple, meat, etc., a heat sensitive color forming layer 53 forming a red color may be provided or a red heat sensitive recording layer 55 may be used for the emphasized indication area 2. As described above, various kinds of colors can be used as the color for the goods figure such as a color of the identical hue, a color capable of causing association, a color for a portion of the commercial product or a color for the entire portion of the goods so long as the customer can associate the goods with the color. For example, in a case of the mackerel, when the figure of the fish is printed in blue, this can associate the customer that it is the mackerel since the mackerel is generally considered as a blue tinted fish, in Japan, although the actual color of the mackerel is not pure blue.

Further, only the blue color is used for the goods figure indication area 4 in this embodiment, it may cope with plural kinds of goods by providing the goods figure indication area 4 of plural colors on one product label 1. That is, in the product label 1, the goods FIG. 12 can be printed to those portions forming colors depending on the targeted commercial product. In the product label of this embodiment, each of the heat sensitive recording layer and the heat sensitive color forming layer are disposed generally on the surface of one label without lamination but the goods FIG. 12 can be printed also in a laminated structure such as two color heat sensitive paper.

A second embodiment of the present invention is now explained with reference to FIG. 3. The same parts as those in the first embodiment are designated by the same reference numerals and are not again explained herein.

In FIG. 2 explained previously, the heat sensitive recording layer 52 and the heat sensitive color forming layer 53 for the goods FIG. 12 are coated not stacked but arranged in parallel on the label. However, in this embodiment, a product label 1 has a such structure that a heat sensitive recording layer 52 is disposed on an undercoat layer 51 comprising clay and the binder resin on a substrate 50 and, after a desensitizing region 56 for partially decreasing or inactivating the heat sensitivity of the heat sensitive recording layer 52 is disposed, the heat sensitive color forming layer 53 and the heat sensitive recording layer 55 for a red emphasizing region are laminated on the desensitized region 56. An intermediate layer is optionally disposed between the desensitizing region 56 and the heat sensitive color forming layer 53. Further, it has a structure that a protection layer 54 is optionally disposed The same ink can be used for each of the ink layers. The ink used for the desensitizing region 56 is obtained by dissolving 1 part by weight of 2-methyl piperazine to 4 parts by weight of a solution formed by diluting IB-F370 (manufactured by Sanyo Kasei Co.) to 15% solution with a 1:1 solution of IPA. and propylene glycol monomethyl ether and coating the solution by flexographic printing to a coating amount of 8 g/m² followed by drying. Further, the heat sensitive color forming layer 53 for the goods FIG. 12 and the heat sensitive recording layer 55 for the red emphasized region are laminated on the desensitizing region 56 to complete the original stock for the product label 1. Further, printing is optionally applied to the protection layer 54 or the portion determined for the name 11 of a store, for example, by offset printing.

As explained for FIG. 2, the product label 1 shown in FIG. 3(A) also causes no color mixing since the heat sensitive recording layer 52 constitute a desensitizing region 56 at a portion where the heat sensitive color forming layer 53 and the heat sensitive recording layer 55 for the emphasis region are laminated and all the sensitive recording layer and the heat sensitive color forming layer can be printed with high sensitivity. In a case of the method of disposing the desensitizing region 56 as shown in FIG. 3, heat sensitive paper that can be erased by an erasing agent can be used. The heat sensitive recording layer 52 is used as the usual goods content indication area 3 and printing is conducted to the heat sensitive recording layer 55 for the blue color forming emphasized region in a case of the content intended to be emphasized such as special price of POP or illustration. The goods FIG. 12 is printed in the heat sensitive color forming layer 53.

In this embodiment, as shown in FIG. 3(A), when the desensitizing region 56 is disposed to a portion of the heat sensitive recording layer 52, a desensitizer is formed by printing to the heat sensitive recording layer 52 so that the heat sensitive recording layer 52 does not form a color. Alternatively, similar effect can also be obtained by printing a heat insulation layer (desensitizing region 56) to a portion on the heat sensitive recording layer 52 and printing the heat sensitive color forming layer 53 on the heat insulation layer (desensitizing region 56) as a method of forming the desensitizing region 56 to a portion of the heat sensitive recording layer 52. It may suffice for the heat insulation layer (desensitizing region 56) that it can interrupt the thermal energy from the thermal head and can provide intense adhesion with the heat sensitive color forming layer 53 and, for example, it is formed by adding a filler to a binder resin and printing the same to about 10 μm on the basis of the dry film thickness. As such a heat insulation layer (desensitizing region 56), a binder resin or a UV-effect region such as an acrylic resin having high heat insulation effect is used particularly preferably.

In the first and the second embodiments, while the effect can be obtained by the formation of the same color in the goods FIG. 12 as the black color for the goods content indication portion 3, it will be apparent that higher effect can be obtained by using the blue color capable of associating the content of the goods to some extent.

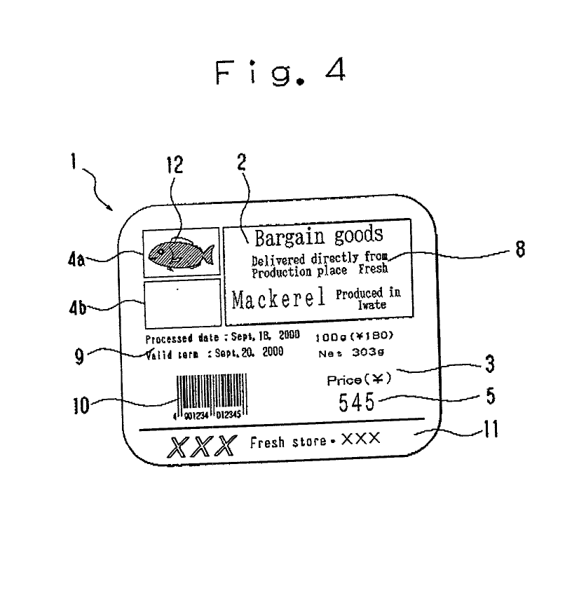

A third embodiment of the present invention is now explained with reference to FIG. 4. The same parts as those in the first embodiment are designated by the same reference numerals, and are not again explained herein.

This embodiment is a modified example of the first and the second embodiments described above. That is, while a single color is used for the goods figure indication area in the first and the second embodiments, an example of two colors is shown in this embodiment. The constitution of the first or the second embodiment requires to previously prepare various kinds of original stocks for the product label 1 such as blue for fish, red for meat and crab, and green for vegetable. For improving this, in this embodiment, goods figure indication areas 4a, 4b are disposed previously to provide the product label 1 with general applicability.

As the specific manufacturing method, this embodiment can be prepared in the same manner as in the first and the second embodiments. However, while CVL is used in a case where the leuco dye is blue, PSD-EM is used for the red color or PSD-3G (manufactured by Nippon Soda Co.) is used for blue color, which is formulated into an ink and coated and dried in the same manner by flexographic printing.

FIG. 4 shows an example in which the emphasized indication area 2 is prepared by offset printing by disposing a desensitizing region 56 with the desensitizer or by the formation of the heat insulation layer as shown in FIG. 3(A), (B) and then coloring the protection layer 54 yellow and forming a black color of the heat sensitive recording layer 52. The heat sensitive recording layer 52 and plural goods figure indication areas 4a, 4b may be printed in parallel on one identical surface as shown in FIG. 2, or it may be a structure of laminating them after disposing the desensitizing region 56 as shown in FIG. 3.

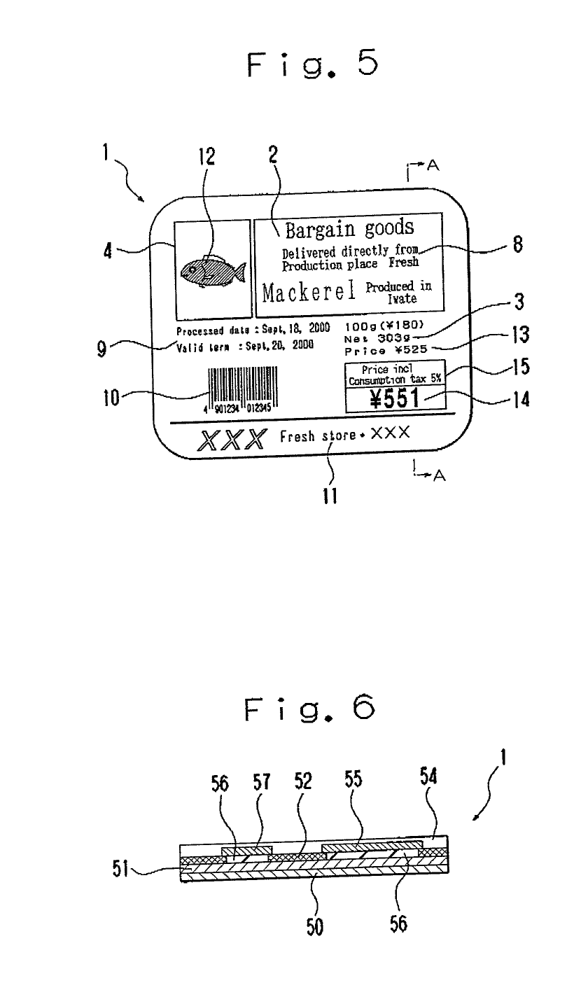

A fourth embodiment of the present invention is now explained with reference to FIG. 5 and 6. The same parts as those in the first embodiment are designated by the same reference numerals, and are not again explained herein.

FIG. 5 shows a product label 1 of this embodiment issued from a product label issuing machine 100 according to the present invention to be described later.

Also in this embodiment, like that in FIG. 1 and FIG. 4, the product label 1 comprises an emphasized indication area 2 and a goods content indication area 3, in which emphasized information 8 such as “bargain goods”, “fresh being delivered directly from the place of production” or “produced in Iwate” is printed. Further, a bar code 10 or date of processing-and-valid term for use 9 is printed in the goods content indication area 3, as well as price 13 without consumption tax is printed.

Further, in this embodiment, a final price indication area 15 is disposed to a portion of the product label 1 and the final paying sum 14 to be paid by a customer is printed based on the result of calculation. Like that in FIG. 1 and FIG. 4, the emphasized indication area 2 and the final price indication area 15 are adapted to form a different color from that of the goods content indication area 3. The color formed to the final price indication area 15 is preferably red.

FIG. 6 shows a cross sectional view of a product label 1 used in the present invention. It has a structure of disposing an undercoat layer 51 on a substrate 50, forming a desensitizing region 56 by partially decreasing or inactivating the heat sensitivity of a heat sensitive recording layer 52 and laminating a heat sensitive recording layer 55 in the emphasized indication area 2 (red color formation), a heat sensitive price recording layer 57 for the final price indication area 15 (forming red color) and a heat sensitive color forming layer 53 (forming blue color) on the desensitizing region 56. An intermediate layer may be disposed optionally between the desensitizing region 56 and the red heat sensitive recording layer 55, the price heat sensitive recording layer 57 and the heat sensitive color forming layer 53. That is, the intermediate layer is disposed so that the effect of the desensitizing region 56 gives no undesired effect on the color formation in each of the heat sensitive layers. The emphasized indication area 2 may be of a color different from that of the final price indication area 15. Further, it may be a structure of not laminating each of the heat sensitive recording layer and the heat sensitive color forming layer as in FIG. 2. Further, while description has been made to an example of printing the sum before addition of the consumption tax and the sum to be paid finally by a customer after addition of the consumption tax, it may also include printing of the sum to be paid finally after applied with a service such as in a case of a membership discount.

In the product label 1 used in the present invention, it is preferred that the heat sensitive price recording layer 57 and the heat sensitive color forming layer 53 for the final price indication area 15 or the heat sensitive recording layer 55 and the heat sensitive recording layer 52 for the emphasized indication area 2 can be printed by the thermal energy of an identical quantity, which can eliminate the requirement for special structure in the issuing machine.

The label of a structure having the heat sensitive recording layer and the heat sensitive color forming layer used for the emphasis indication area 2, the final price indication area 15 and the goods figure indication area 4 on the heat sensitive recording layer 52 according to the first to fourth embodiments can utilize the heat sensitive paper so long as the desensitizing region 56 can be formed to the heat sensitive recording layer 52. Further, the color for each of the indication areas 2, 15 and 4 is not restricted only to the example of each embodiment but any color may be used so long as it is ease to see by customers. Further, the product label 1 of the embodiment is shown as an example of a weight measured label but it may be appended to goods whose contents are not visible. For example, it is applicable to any product label 1 such as a label for fruits and other weight measured label.

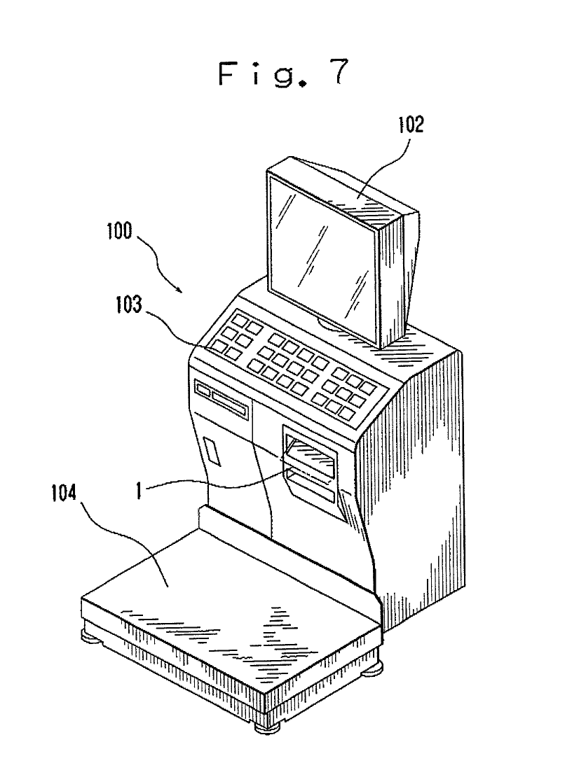

A fifth embodiment of the present invention is now, explained with reference to FIG. 7 to 11. The same parts as those in the first embodiment are designated by the same reference numerals, and are not again explained herein.

FIG. 7 shows a constitutional view for the appearance of a product label issuing machine 100 of this embodiment that issues product labels 1 as described above. This embodiment relates to a product label issuing machine 100 which can print a goods FIG. 12 and a sum to be paid by a customer (final price) by emphasized letters on a product label.

The product label issuing machine 100 comprises for example, an external interface (not illustrated in FIG. 7) 101, a display device 102 of a touch panel structure, a key board 103 and a weight measuring device 104.

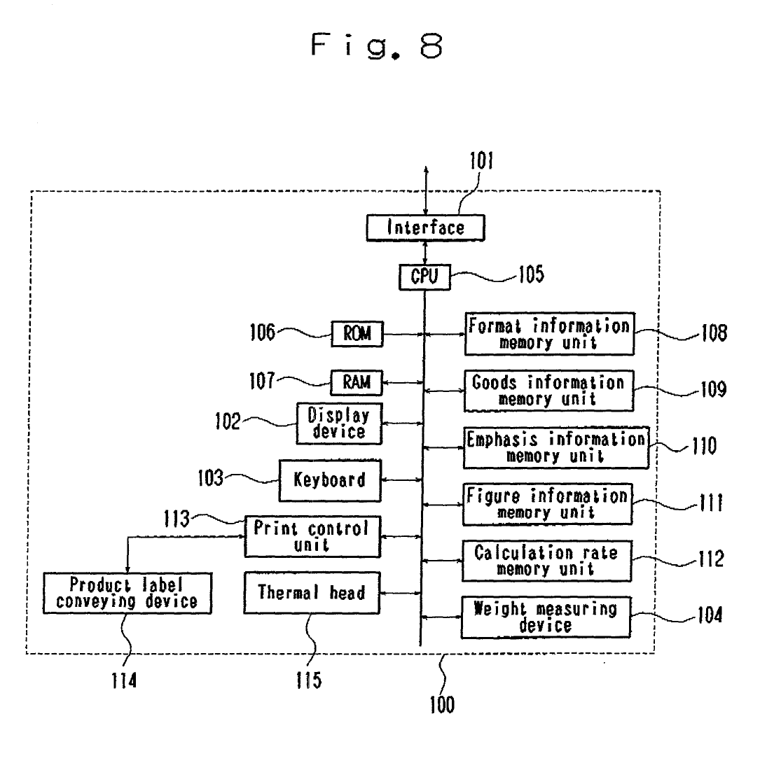

FIG. 8 shows an example of a hardware constitution of the product label issuing machine 100. When a product label code or a commercial product code is inputted from a touch panel key in the display device 102 or a key board 103, a format of a product label 1 corresponding to the code is read from a format information memory unit 108 and temporarily stored in RAM 107 according to a program stored in ROM 106. As the read format information the position, the size and the design for a goods content indication area 3, an emphasized indication area 2, a goods figure indication area 4 and a final price indication area 15, and the size of the product label 1 itself are stored in RAM 107.

Then, the weight of the goods is read from the weight measuring device 104 and stored in the same manner into the RAM 107. Then, the content to be printed on the goods content indication area 3 is read from the goods information memory unit 109 in accordance with the commercial product code and incorporated with the processing date-and-valid term for use and stored in the RAM 107. In the same manner, the content to be printed in the emphasized indication area 2 is read from an emphasized information memory unit 110 and the content to be printed in the goods figure indication area 4 is read from the design information memory unit 111 and stored in the RAM 107. Further, the CPU 105 reads, for example, unit price for 100 g from the goods information memory unit 109, calculates the goods price 13 based on the weight data already stored in the RAM 107 and stores the same in the RAM 107 in accordance with the inputted code. At the same time, it reads, for example, a consumption tax rate from a calculation rate memory unit 112, calculates a final price 14 based on the consumption tax and the goods price 13 (price calculation unit), and stores the data in the RAM 107.

In the case where the data read from the memory units 109, 110, 111 and 112 are changed by the operation, for example, when the price is changed from the key board 103, it can also change other information (final price in this case) depending on the change of the information and can transfer the same to the RAM 107.

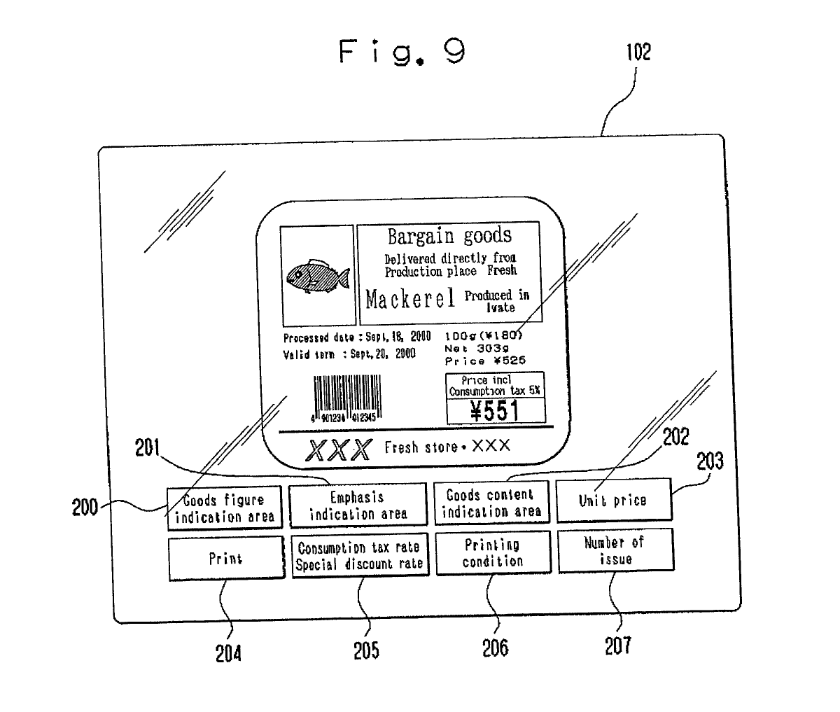

Based on the data stored in the RAM 107, the image of the product label 1 to be prepared is displayed on the screen of the display device 102 as shown in FIG. 9. Further, the screen displays the stored image information and the operation information for changing the content of the indication (content of printing). For example, the name for each of the indication areas such as “goods figure indication area” and “emphasized indication area” is key-displayed as keys 200 to 207 and when a key part is touched, the already registered stored information can be displayed and selected.

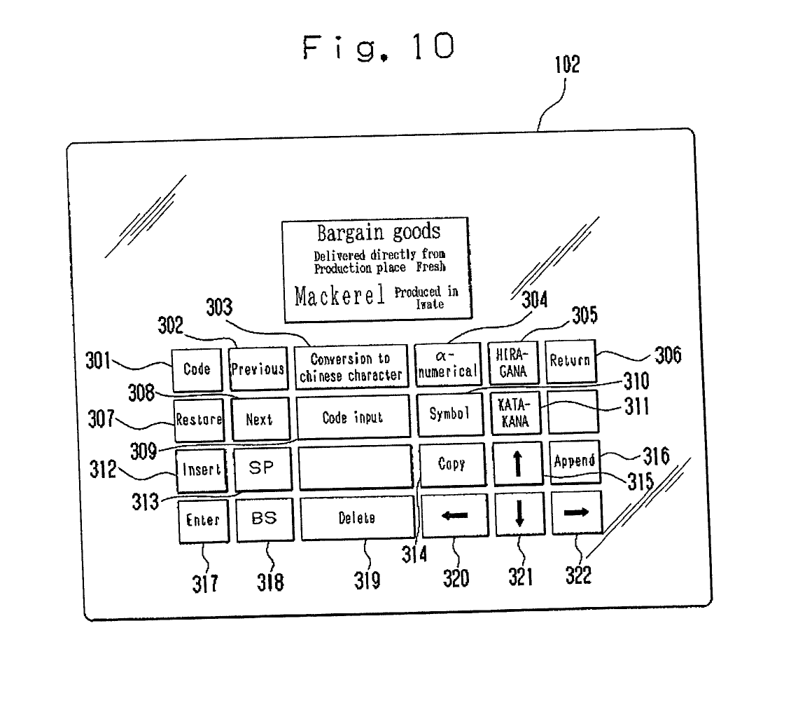

For example, upon touch on the emphasized indication area key 201, the screen display can be switched to that shown in FIG. 10. In FIG. 10, the content set for the emphasized indication area 2 is displayed on the screen and various kinds of keys 301 to 322 are disposed such that the content for the setting can be changed. In a case where the content to be printed in the emphasized indication area 2 has already been registered in the emphasized information memory unit 110, when the number is inputted from the key board 103 and then the code key 301 is pressed, indication corresponding to the code appears on the screen. A cursor on the display screen is positioned to a place intended for change and the key 304, 305, 311, 310, 303 for alpha numerical letter, HIRAGANA, KATAKANA, symbol or conversion to CHINESE character is operated for input. When the setting can be changed finally, the content to be printed in the emphasized indication area 2 is changed automatically by the pressing of the return key 306 (the display screen returns to FIG. 9 and data stored in the RAM 107 is also changed at the same time with the change of the content). When a restoration key 307 is pressed before pressing the return key 306, it can be also returned to the screen before change. As described above, change for each of the indication areas is conducted in the same manner.

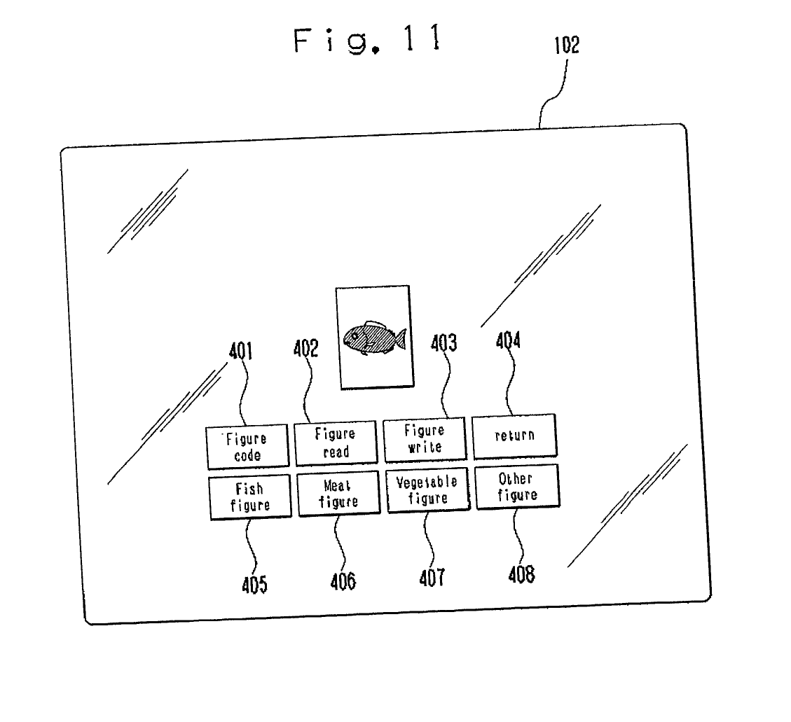

Further, the content of the printing regarding the goods FIG. 12 is changed by pressing a goods figure change indication area key 200 on the screen display shown in FIG. 9 to switch the screen display to that shown in FIG. 11. Upon change, after designating the number from the key board 103, when a figure code key 401 is pressed, the content designated by the figure code is displayed on the screen. Further, when a fish figure key 405 or a meat design key 406 for each section is selected, a list stored therein is displayed and choice is made from the list. When the return key 404 is pressed after decision, the screen display is returned to that shown in FIG. 8 as described above and the display content and the content of the RAM 107 are updated. When new registration of the goods FIG. 12 is prepared, the procedure is conducted in the goods figure indication area 109 relative to a personal computer (not illustrated) by way of the interface 101 and the CPU 105. When the stored figure is transferred to the personal computer or read from the personal computer, this can be conducted by a figure read key 402 (personal computer→product label issuing machine 100) and a figure writing key 403 (product label issuing machine 100→personal computer).

Also for the price or the like, the screen display shown in FIG. 9 can be switched to the price screen by inputting the unit price key 203 and change is possible also in the same manner.

Obviously, numerous modifications and variations of the present invention are possible in the light of the above teachings. It is therefore to be understood that within the scope of the appended claims, the invention may be practiced otherwise than as specifically described herein.

1. A product label comprising:
sales information for printed goods; and
a goods figure indicating the form of the printed goods or a portion thereof.

2. A product label according to claim 1, wherein the goods figure is printed in a color that associates the goods.

3. A product label according to claim 2, including:
a first heat sensitive recording layer coloring with certain color by applying thermal energy; and
a second heat sensitive recording layer disposed partially in a portion on the label, and coloring with different color to the first heat sensitive recording layer by applying thermal energy,
wherein the goods figure is appeared on the second heat sensitive recording layer by thermal printing.

4. A product label according to claim 3, wherein the first heat sensitive recording layer and the second heat sensitive recording layer color by the application of at least an identical quantity of thermal energy.

5. A product label according to claim 3 or 4, wherein the second heat sensitive recording layer is laminated on a desensitizing region formed by partially decreasing or inactivating the heat sensitivity of the first heat sensitive recording layer.

6. A product label comprising:
a goods content indication area in which a sum to be paid by a customer and other information are to be printed;
a sum to be paid by a customer printed in the goods content indication area; and
information other than the sum to be paid by the customer printed in the goods content indication area,
wherein the sum to be paid by the customer is printed by emphasizing letters which are emphasized relative to other information printed in the goods content indication area.

7. A product label according to claim 6, wherein the emphasizing letters are printed in a color different from that for other information printed in the goods content indication area.

8. A product label according to claim 7, further comprising:
a first heat sensitive recording layer coloring with certain color by applying thermal energy; and
a second heat sensitive recording layer disposed partially in a portion on the label, and coloring with different color to the first heat sensitive recording layer by applying thermal energy,
wherein the sum to be paid by the customer is appeared on the second heat sensitive recording layer by thermal printing.

9. A product label according to claim 8, wherein the first heat sensitive recording layer and the second heat sensitive recording layer color by the application of at least an identical quantity of thermal energy.

10. A product label according to claim 8, wherein the second heat sensitive recording layer is laminated on the desensitizing region formed by partially decreasing or inactivating the heat sensitivity of the first heat sensitive recording layer.

11. A product label issuing machine for issuing a product label in which the sales information of goods is printed comprising:
a thermal head for conducting printing by heating the heat sensitive recording layer of the product label;
design information memory means for storing the information of the goods figure that indicates the form of the goods or a portion thereof and of the color for the goods figure; and
goods information memory means for storing the sales information of the goods,
wherein the information stored in the figure information memory means and the goods information memory means are read sequentially in the order of printing and the goods figure and the sales information of the goods are printed by the thermal head on the product label.

12. A product label issuing machine for issuing a product label in which the sales information of goods is printed comprising:
a thermal head for conducting printing by heating the heat sensitive recording layer disposed to the product label;
goods information memory means for storing the sales information of the goods,
calculation rate memory means for storing the information for calculating the final price of the goods; and
price calculation means for calculating the final price to be paid by a customer based on the information regarding the price of the goods store in the goods information memory means and the information stored in the calculation rate memory means,
wherein the final price to be paid by the customer and the sales information of the goods are printed by the thermal head to the product label based on the final price calculated by the price calculation means and the sales information of the goods stored in the goods information memory means.
